(19) United States
(12) Patent Application Publication
(10) Pub. No.: US 2019/0196705 A1
(43) Pub. Date: Jun. 27, 2019

(54) MOBILE TERMINAL AND METHOD FOR IMPLEMENTING CUSTOM APPLICATIONS USING THE SAME

(71) Applicant: JRD COMMUNICATION (SHENZHEN) LTD, Shenzhen (CN)

(72) Inventor: Binjian Tu, Shenzhen (CN)

(21) Appl. No.: 16/289,670

(22) Filed: Mar. 1, 2019

Related U.S. Application Data
(63) Continuation of application No. PCT/CN2017/094281, filed on Jul. 25, 2017.

(30) Foreign Application Priority Data
Sep. 26, 2016 (CN) 201610850146.4

(51) Int. Cl. G06F 3/0484; G06F 3/0482

(52) U.S. Cl. CPC G06F 3/04847; G06F 3/0482

(57) ABSTRACT

The present disclosure provides a mobile terminal and a method for implementing customized applications using the same, wherein the method includes: displaying an operating and editing interface of customized applications, wherein the operating and editing interface of customized applications displays operation starting conditions and their corresponding operation options; receiving a starting condition editing instruction and its corresponding operation option selecting instruction generated by triggering the operating and editing interface of customized applications; and responding to the instructions, obtaining and storing a selected operation option and its corresponding starting conditions, such that the mobile terminal automatically implements an operation corresponding to the operation option when the starting conditions are met, and the personalized needs and experience of the user can be met and improved.

### CROSS-REFERENCE TO RELATED APPLICATION

The present application is a continuation-application of International (PCT) Patent Application No. PCT/CN2017/094281 filed on Jul. 25, 2017, which claims foreign priority of Chinese Patent Application No. 201610850146.4, filed on Sep. 26, 2016 in the State Intellectual Property Office of China, the entire contents of which are hereby incorporated by reference.

### TECHNICAL FIELD

The present disclosure relates to the field of mobile communication technology, and more particularly, to a mobile terminal and a method for implementing customized applications using the same.

### BACKGROUND

With the development of mobile communication technology, smart devices are more and more popular, and the variety of applications applied to smart devices is increasing.

Faced with so many applications, it is difficult for a user to select an application that is the most suitable for him/her in these applications. Applications in the current market mainly aim at some needs of users. When a user wants to customize some special needs of himself/herself, there is no way unless the user is a developer. Particularly, when the needs of the user are relatively personalized, there is especially no way.

### SUMMARY

In order to solve the above technical problem, the present disclosure adopts another technical solution as follows: providing a method for implementing customized applications of a mobile terminal, including: displaying an operating and editing interface of customized applications, wherein the operating and editing interface of customized applications displays operation starting conditions and their corresponding operation options; receiving a starting condition editing instruction and its corresponding operation option selecting instruction generated by triggering the operating and editing interface of customized applications; and responding to the instructions, obtaining and storing a selected operation option and its corresponding starting conditions, such that the mobile terminal automatically implements an operation corresponding to the operation option when the starting conditions are met.

According to one embodiment of the present disclosure, the displaying an operating and editing interface of customized applications may include: displaying a selectable menu of starting conditions; the receiving the starting condition editing instruction generated by triggering the operating and editing interface of customized applications may include: receiving a starting condition editing instruction generated by selecting the starting condition in the selectable menu of starting conditions.

According to one embodiment of the present disclosure, the displaying the operating and editing interface of customized applications may include: displaying all the operation options that can be started by the selected starting condition in the same interface after receiving starting condition editing instruction generated by triggering of the operating and editing interface of customized applications; the receiving the operation option selecting instruction generated by triggering the operating and editing interface of customized applications may include: receiving an operation option selecting instruction generated by selecting the operation option.

According to one embodiment of the present disclosure, the displaying the operating and editing interface of customized applications may include: displaying a selectable menu of operation options; the receiving operation option selecting instruction generated by triggering of the operating and editing interface of customized applications may include: receiving operation option selecting instruction generated by selecting an operation option in the selectable menu of operation options

According to one embodiment of the present disclosure, using the displaying the operating and editing interface of customized applications may include: displaying all the starting conditions that can trigger the selected operation option in the same interface after receiving operation option selecting instruction generated by selecting the operation option in the selectable menu of operation options; the receiving the starting condition editing instruction generated by triggering the operating and editing interface of customized applications may include: receiving a starting condition editing instruction generated by selecting the staring conditions.

According to one embodiment of the present disclosure, the obtaining and storing the selected operation option and its corresponding starting conditions may include: obtaining a selected operation option and its corresponding starting conditions and storing them to a database, wherein the database comprises at least two pieces of record, and each piece of record comprises a selected operation option and its corresponding starting conditions and operation time length.

The present disclosure further adopts a technical solution as follows: providing a mobile terminal for implementing customized applications, including: a display, configured to display an operating and editing interface of customized applications, wherein the operating and editing interface of customized applications displays operation starting conditions and their corresponding operation options; a processor, configured to receive and respond to a starting condition editing instruction and its corresponding operation option selecting instruction generated by triggering the operating and editing interface of customized applications; and a storage, configured to obtain and store a selected operation option and its corresponding starting conditions, such that the mobile terminal automatically implements an operation corresponding to the operation option when the starting conditions are met.

According to one embodiment of the present disclosure, the display is configured to display a selectable menu of starting conditions; the processor is configured to receive a starting condition editing instruction generated by selecting the starting condition in the selectable menu of starting conditions.

According to one embodiment of the present disclosure, the display is configured to display operation options that can be started by the selected starting condition in the same interface after receiving starting condition editing instruction generated by triggering of the operating and editing interface of customized applications; the processor is configured to receive an operation option selecting instruction generated by selecting the operation options.

According to one embodiment of the present disclosure, the display is configured to display a selectable menu of operation options; the processor is configured to receive operation option selecting instruction generated by selecting an operation option in the selectable menu of operation options.

According to one embodiment of the present disclosure, the display is configured to display all the starting conditions that can trigger the selected operation option in the same interface after receiving operation option selecting instruction generated by selecting the operation option in the selectable menu of operation options; the processor is configured to receive a starting condition editing instruction generated by selecting the staring conditions.

According to one embodiment of the present disclosure, the storage is configured to obtain a selected operation option and its corresponding starting conditions and store them to a database, wherein the database comprises at least two pieces of record, and each piece of record comprises a selected operation option and its corresponding starting conditions and operation time length.

Beneficial effects of the present disclosure may be as below: different from the related art, in the method for implementing customized applications of mobile terminals provided by the present disclosure, since an operating and editing interface of customized applications is provided, a user can customize and edit starting conditions and their corresponding operation options through the operating and editing interface of customized applications, such that the mobile terminal automatically can implement the operations corresponding to the operation options when the starting conditions are met, the personalized needs and experience of the user can be met and improved.

### BRIEF DESCRIPTION OF THE DRAWINGS

In order to illustrate the technical solutions of the embodiments of the present disclosure more clearly, drawings required to be used in the description of the embodiments will be briefly introduced below. Obviously, the drawings in the following description are merely some embodiments of the present disclosure. For one of ordinary skill in the art, other drawings can also be obtained according to these drawings on the premise of paying no creative work.

FIG. 1 is a schematic view of a flowchart of one embodiment of a method for implementing customized applications of a mobile terminal of the present disclosure.

FIG. 2 is a schematic view of a flowchart of another embodiment of a method for implementing customized applications of a mobile terminal of the present disclosure.

FIG. 3 is a specific application example of the embodiment of FIG. 2.

FIG. 4 is a schematic view of a flowchart of one embodiment of a method for implementing customized applications of a mobile terminal of the present disclosure.

FIG. 5 is a structural schematic view of one embodiment of a mobile terminal for implementing customized applications provided by the present disclosure.

FIG. 6 is a structural schematic view of another embodiment of a mobile terminal for implementing customized applications provided by the present disclosure.

### DETAILED DESCRIPTION

Technical solutions of the embodiments of the present application will be described clearly and completely below in combination with the drawings of the embodiments of the present disclosure. Obviously, the described embodiments are merely some embodiments of the present disclosure, rather than all embodiments. Based on the embodiments of the present disclosure, all of other embodiments obtained by one of ordinary skill in the art on the premise of making no creative work fall within the protection scope of the present disclosure.

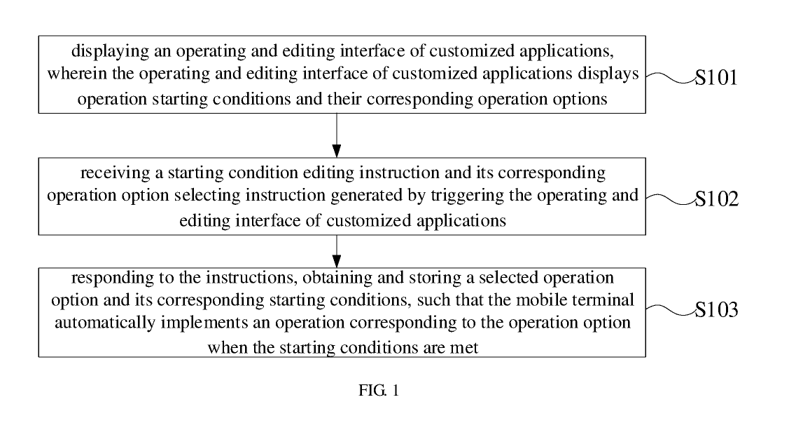

Referring to FIG. 1, one embodiment of a method for implementing customized applications of a mobile terminal of the present disclosure may include the following blocks:

S101: the mobile terminal may display an operating and editing interface of customized applications, wherein the operating and editing interface of customized applications displays operation starting conditions and their corresponding operation options.

On the premise of ensuring safety and operability, a system programming interface of a mobile terminal, which is open for developers, is embellished and then transformed into a simplified, humanized, and safe operating and editing interface of customized applications, and users can perform personalized configurations in the operating and editing interface of customized applications.

S102: the mobile terminal may receive a starting condition editing instruction and its corresponding operation option selecting instruction generated by triggering the operating and editing interface of customized applications.

Users can edit or select their own starting conditions and operation options.

S103: the mobile terminal may respond to the instructions, obtain and store a selected operation option and its corresponding starting conditions, such that the mobile terminal automatically implements an operation corresponding to the operation option when the starting conditions are met.

In the method for implementing customized applications of a mobile terminal provided by the present disclosure, since an operating and editing interface of customized applications is provided, a user can customize and edit starting conditions and their corresponding operation options through the operating and editing interface of customized applications, such that the mobile terminal automatically can implement the operations corresponding to the operation options when the starting conditions are met, the personalized needs and experience of the user can be met and improved.

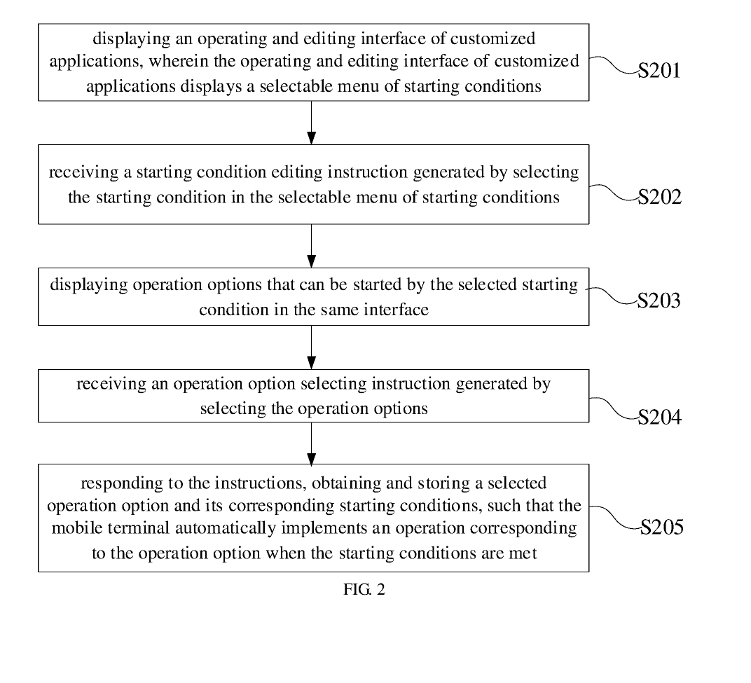

Referring to FIG. 2, another embodiment of a method for implementing customized applications of a mobile terminal of the present disclosure may include the following blocks:

S201: the mobile terminal may display an operating and editing interface of customized applications, wherein the operating and editing interface of customized applications displays a selectable menu of operation starting conditions.

The operating and editing interface of customized applications may display a selectable menu of operation starting conditions, wherein the selectable menu may include starting conditions that are often selected by users, such as a time condition, an equipment environment condition, a network state condition, and so on. In particular, the time condition may include specific time points at morning, at noon, and at evening, and specific dates of the first ten days of a month, of the middle ten days of a month, and of the last ten days of a month, and so on; the equipment environment condition may include remaining electricity, remaining flow, and so on; and the network state condition may include access conditions of strange numbers, the absence of the wireless network, and so on. If the selectable menu of starting conditions cannot meet a user's need, the user can further edit new starting conditions and add them into the selectable menu, for example, “a mobile device leaves preset longitude and latitude”, “a touch screen is not touched by its master's fingerprint”, and so on. The selectable menu may include rich content and can greatly meet customers' needs.

The selectable menu may further provide a smart searching interface. If a user cannot find his/her required starting conditions conveniently, by searching key words, various selectable options that meet the starting conditions required by the user can be found, such that the user can quickly find the starting conditions that meet the need of the user.

S202: the mobile terminal may receive a starting condition editing instruction generated by selecting the starting condition in the selectable menu of starting conditions.

The mobile terminal may receive a starting condition selected by the user. The starting conditions may include at least one kind of option in the selectable menu. In one embodiment, the starting condition may be generally one kind of options in the selectable menu. For example, 7:00, 9:00, when being in a company, when the mobile device leaves preset longitude and latitude, when the electricity is less than 10%, when the remaining flow is less than 100 MB, when a touch screen is not touched by its master's fingerprint, and so on. The starting conditions may also be a combination of two or more kinds of options in the selectable menu. For example, when the mobile device leaves preset longitude and latitude and the touch screen is not touched by its master's fingerprint, or it is 7:00 and the electricity is less than 10%, and so on.

S203: the mobile terminal may display operation options that can be started by the selected starting condition in the same interface.

After receiving starting condition editing instruction generated by triggering of the operating and editing interface of customized applications, the mobile terminal displays all the operation options that can be started by the selected starting condition in the same interface. The operation options may include specific operation behaviors often selected by the user, which specifically include but are not limited to turning on, turning off, alarm clock, mute state, auto-dialing, auto-messaging, auto-answering, rejecting incoming calls, switching on or off data connection, starting applications, and so on.

S204: the mobile terminal may receive a starting condition editing instruction generated by selecting the staring conditions.

The mobile terminal receives the operation option selected by the user. The selected operation option may further include tagged content. In particular, the tagged content may include tagged topics and tagged behaviors. For example, a tagged topic of auto-dialing is “waking your son up”, and a tagged behavior is “dialing the number: 13500000000, playing ‘March of the Volunteers.mp3’ when the call is answered, and ignoring when the call is rejected”, and so on.

S205: the mobile terminal may respond to the instructions, obtain and store a selected operation option and its corresponding starting conditions, such that the mobile terminal automatically implements an operation corresponding to the operation option when the starting conditions are met.

The mobile terminal may make a response according to the received starting condition editing instructions and operation option selecting instructions, and obtain and store a selected operation option and its corresponding starting conditions, such that the mobile terminal automatically implements an operation corresponding to the operation option when the starting conditions are met.

In particular, the selected operation option and its corresponding starting conditions are obtained and stored into a database, wherein the database may include at least two pieces of record, and each piece of record may include a selected operation option and its corresponding starting conditions and operation time length.

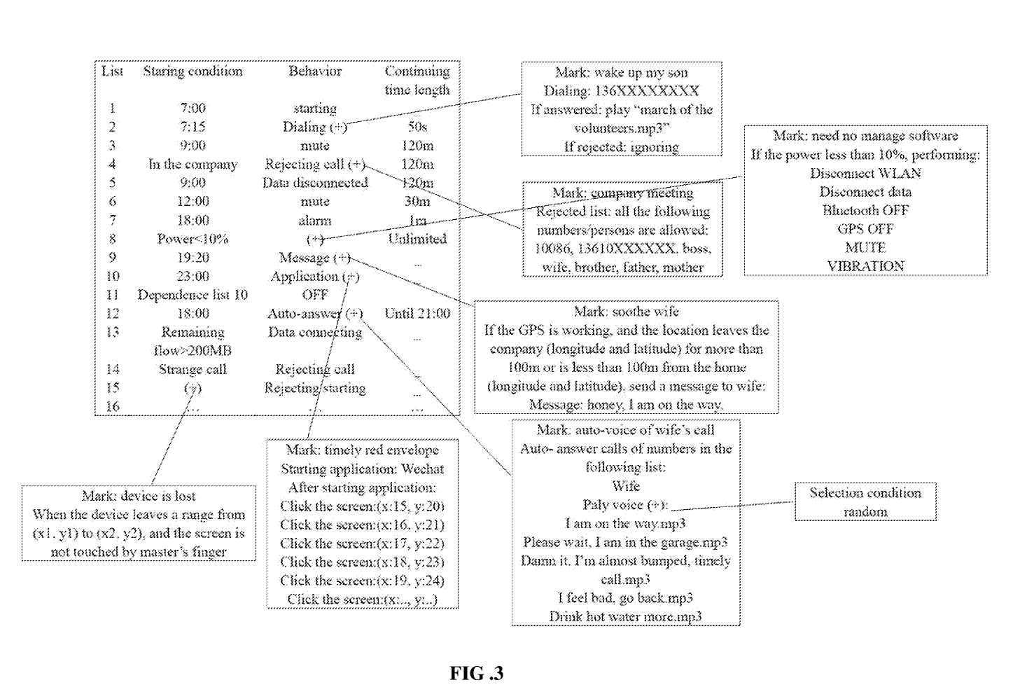

In this embodiment, the operation options that can be started by the provided selectable menu of starting conditions and the selected starting conditions have rich content and can be edited and added. The operation options may further include tagged content, which may almost meet all personalized needs of users, and deliver the maximum control of mobile terminal application management to the user, such that the user may achieve the most extensive degree of freedom and the best experience, and thus the user really feels that “he/she owns it”. In a word, the present disclosure may allow a user to perform a deep behavior customization for a mobile terminal. For example, a user hope that the mobile terminal automatically completes a thing in what manner on what time/in what place/in what conditions. As shown in FIG. 3, an actual application example is provided.

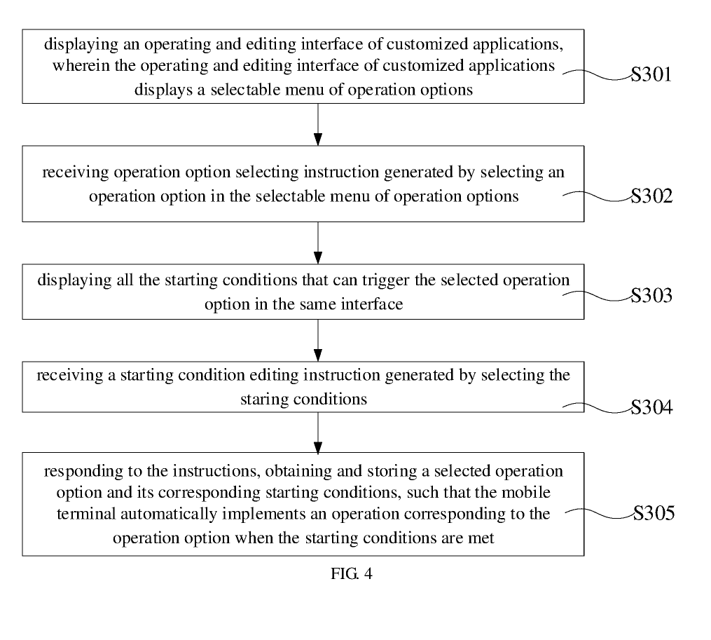

Referring to FIG. 4, one embodiment of a method for implementing customized applications of a mobile terminal of the present disclosure may include the following blocks:

S301: displaying an operating and editing interface of customized applications, wherein the operating and editing interface of customized applications displays operation starting conditions and their corresponding operation options;

S302: receiving operation option selecting instruction generated by selecting the operation option in the selectable menu of operation options;

S303: displaying all the operation options that can be started by the selected starting condition in the same interface;

S304: receiving a starting condition editing instruction generated by selecting the staring conditions; and

S305: responding to the instructions, obtaining and storing a selected operation option and its corresponding starting conditions, such that the mobile terminal automatically implements an operation corresponding to the operation option when the starting conditions are met.

This embodiment and the above embodiment have generally identical flows and identical advantage effects. The difference may be that: in the second embodiment, the starting condition editing instruction is selected at first, and thus the operation option selecting instruction that can be started by the starting condition is selected; in this embodiment, the operation option selecting instruction is selected at first, and thus the starting condition editing instruction that can trigger the selected operation option is selected. The content of the starting condition editing instructions and of the operation option selecting instructions may do not change. The method provided by the present disclosure can preset that the mobile terminal performs a preview operation according to the starting condition editing instruction and operation option selecting instruction selected by the customized application, and can also preset how to select the starting conditions and the operation options in the preview, and so on.

In other embodiments, references between customized applications, or nestings between customized applications, or even cyclic and repetitive operations for each customized application, may be also allowed.

The present disclosure may differ from the “manager” applications on the market with limited functions. The present disclosure focuses on “user customization”, allows user to freely customize their required starting conditions and operation option behaviors, and is not limited to limited functional openness and limited condition restriction. For example, a user needs to set a behavior for his/her mobile terminal: when the electricity is less than 10%, switching off data link, switching off WLAN, switching off Bluetooth, switching off NFC, switching on a mute mode, switching vibration, and so on. In the exemplary explanation, the condition that “the electricity is less than 10%” can be customized by the user; the user can also select completing operations such as automatically switching on the data link when “data flow is above 300 MB”, this is not a problem at all. Compared to the “manager” applications on the market, which can only have a few particular options allowing users to select, the present disclosure derive numerous options. Furthermore, the “manager” applications have no way to achieve that: when a particular user makes an incoming call, a mobile terminal can automatically answer, and play preset audio for the particular user to listen. For instance, the “manager” applications have no way to involve continuous observation of current locations of users, and open a series of device behaviors according to the locations of users. On the market, there is no any kind of applications can meet the needs that allowing a user to customize “previewing” a series of screen touch operation, and thus using a device to play the touch operation “previewed” by the user back on particular conditions.

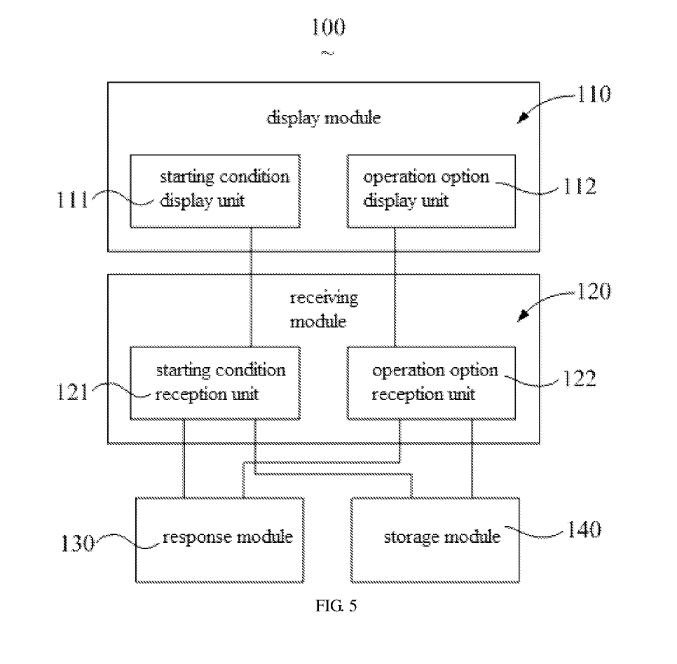

Referring to FIG. 5, FIG. 5 is a structural schematic view of one embodiment of a mobile terminal for implementing customized applications provided by the present disclosure.

As shown in FIG. 5, the mobile terminal 100 may include a display module 110, a receiving module 120, a response module 230, and a storage module 140.

The display module 110 may be configured to display an operating and editing interface of customized applications, wherein the operating and editing interface of customized applications displays operation starting conditions and their corresponding operation options. The receiving module 120 may be configured to receive a starting condition editing instruction and its corresponding operation option selecting instruction generated by triggering the operating and editing interface of customized applications in the display module 110. The response module 130 may be configured to respond the starting condition editing instruction and its corresponding operation option selecting instruction received by the receiving module 120. The storage module 140 may be configured to store a selected operation option and its corresponding starting conditions obtained by the receiving module 120 into a database. In particular, the database may include at least two pieces of record, and each piece of record may include a selected operation option and its corresponding starting conditions and operation time length.

In this embodiment, the display module 110 may include a starting condition display unit 111 and an operation option display unit 112, wherein, the starting condition display unit 111 may be configured to display a selectable menu of starting conditions; and the operation option display unit is configured to display a selectable menu of operation options.

The receiving module 120 may include a starting condition reception unit 121 and an operation option reception unit 122. In particular, the starting condition reception unit 121 may be configured to receive starting condition editing instruction generated by selecting a starting condition in the selectable menu of starting conditions; and the operation option reception unit 122 may be configured to receive operation option selecting instruction generated by selecting an operation option in the selectable menu of operation options.

The modules of the aforementioned mobile terminal 100 can perform corresponding step in the aforementioned method embodiment respectively. Therefore, the modules may be not repeatedly described here, and the details can refer to the descriptions of the above corresponding blocks.

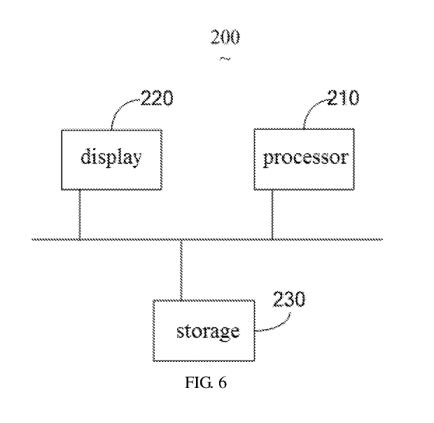

Referring to FIG. 6, FIG. 6 is a structural schematic view of another embodiment of a mobile terminal for implementing customized applications of the present disclosure.

As shown in FIG. 6, the mobile terminal may include: a processor 210, and a display 220 and a storage 230 which are coupled with the processor 210.

The display 220 may be configured to display an operating and editing interface of customized applications. In particular, the operating and editing interface of customized applications may display operation starting conditions and their corresponding operation options.

The storage 230 may be configured to store the operation options and their corresponding starting conditions displayed by the display 220, a selectable menu of starting conditions, a selectable menu of operation options, operation time length, instruction responded by the processor 210, instruction received by the processor 210, and so on.

The processor 210 is configured to receive a starting condition editing instruction and its corresponding operation option selecting instruction generated by triggering of the operating and editing interface of customized applications, and respond the instruction, such that the mobile terminal automatically implements operations corresponding to operation options when starting conditions are met.

In one embodiment, the display 220 may be further configured to display a selectable menu of at least one of the starting conditions and operation options.

In one embodiment, the processor 210 may be further configured to receive starting condition editing instruction generated by selecting a starting condition in the selectable menu of starting conditions and receive operation option selecting instruction generated by selecting an operation option in the selectable menu of operation options.

In conclusion, one of ordinary skill in the art can easily understand that: in the method for implementing customized applications of a mobile terminal provided by the present disclosure, since an operating and editing interface of customized applications is provided, a user can customize and edit starting conditions and their corresponding operation options through the operating and editing interface of customized applications, such that the mobile terminal automatically implements the operations corresponding to the operation options when the starting conditions are met, personalized needs of the user can be met, and the user's experience is improved.

The above are merely embodiments of the present disclosure and are not intended to limit the patent scope of the present disclosure. Any modifications of equivalent structure or equivalent process made on the basis of the content of the description and drawings of the present disclosure, or direct or indirect application of the present disclosure to other related technical fields shall similarly fall within the scope of patent protection of the present disclosure.

What is claimed is:

1. A method for implementing customized applications of a mobile terminal, comprising:
displaying an operating and editing interface of customized applications, wherein the operating and editing interface of customized applications displays operation starting conditions and their corresponding operation options;
receiving a starting condition editing instruction and its corresponding operation option selecting instruction generated by triggering the operating and editing interface of customized applications; and
responding to the instructions, obtaining and storing a selected operation option and its corresponding starting conditions, such that the mobile terminal automatically implements an operation corresponding to the operation option when the starting conditions are met.

2. The method according to claim 1, wherein,
the displaying an operating and editing interface of customized applications comprises:
displaying a selectable menu of starting conditions;
the receiving the starting condition editing instruction generated by triggering the operating and editing interface of customized applications comprises:
receiving a starting condition editing instruction generated by selecting the starting condition in the selectable menu of starting conditions.

3. The method according to claim 2, wherein,
the displaying the operating and editing interface of customized applications comprises:
displaying operation options that can be started by the selected starting condition in the same interface after receiving starting condition editing instruction generated by triggering of the operating and editing interface of customized applications;
the receiving the operation option selecting instruction generated by triggering the operating and editing interface of customized applications comprises:
receiving an operation option selecting instruction generated by selecting the operation options.

4. The method according to claim 1, wherein,
the displaying the operating and editing interface of customized applications comprises:
displaying a selectable menu of operation options;
the receiving operation option selecting instruction generated by triggering of the operating and editing interface of customized applications comprises:
receiving operation option selecting instruction generated by selecting an operation option in the selectable menu of operation options.

5. The method according to claim 4, wherein,
the displaying the operating and editing interface of customized applications comprises:
displaying all the starting conditions that can trigger the selected operation option in the same interface after receiving operation option selecting instruction generated by selecting the operation option in the selectable menu of operation options;
the receiving the starting condition editing instruction generated by triggering the operating and editing interface of customized applications comprises:
receiving a starting condition editing instruction generated by selecting the staring conditions.

6. The method according to claim 1, wherein,
the obtaining and storing the selected operation option and its corresponding starting conditions comprises:
obtaining a selected operation option and its corresponding starting conditions and storing them to a database, wherein the database comprises at least two pieces of record, and each piece of record comprises a selected operation option and its corresponding starting conditions and operation time length.

7. A mobile terminal for realizing customized applications, comprising:
a display, configured to display an operating and editing interface of customized applications, wherein the operating and editing interface of customized applications displays operation starting conditions and their corresponding operation options;
a processor, configured to receive and respond to a starting condition editing instruction and its corresponding operation option selecting instruction generated by triggering the operating and editing interface of customized applications; and
a storage, configured to obtain and store a selected operation option and its corresponding starting conditions, such that the mobile terminal automatically implements an operation corresponding to the operation option when the starting conditions are met.

8. The mobile terminal according to claim 7, wherein
the display is configured to display a selectable menu of starting conditions;
the processor is configured to receive a starting condition editing instruction generated by selecting the starting condition in the selectable menu of starting conditions.

9. The mobile terminal according to claim 8, wherein
the display is configured to display operation options that can be started by the selected starting condition in the same interface after receiving starting condition editing instruction generated by triggering of the operating and editing interface of customized applications;
the processor is configured to receive an operation option selecting instruction generated by selecting the operation options.

10. The mobile terminal according to claim 7, wherein
the display is configured to display a selectable menu of operation options;
the processor is configured to receive operation option selecting instruction generated by selecting an operation option in the selectable menu of operation options.

11. The mobile terminal according to claim 10, wherein
the display is configured to display all the starting conditions that can trigger the selected operation option in the same interface after receiving operation option selecting instruction generated by selecting the operation option in the selectable menu of operation options;
the processor is configured to receive a starting condition editing instruction generated by selecting the staring conditions.

12. The mobile terminal according to claim 7, wherein
the storage is configured to obtain a selected operation option and its corresponding starting conditions and store them to a database, wherein the database comprises at least two pieces of record, and each piece of record comprises a selected operation option and its corresponding starting conditions and operation time length.
